(19) United States
(12) Patent Application Publication
(10) Pub. No.: US 2009/0183422 A1
(43) Pub. Date: Jul. 23, 2009

(54) PROCESS AND SYSTEM FOR PREPARATION OF BIO-FUELS

(76) Inventor: Robert D. WYSONG, Wilmington, DE (US)

Correspondence Address: MCGUIREWOODS, LLP, 1750 TYSONS BLVD, SUITE 1800, MCLEAN, VA, 22102, US

(21) Appl. No.: 12/354,495

(22) Filed: Jan. 15, 2009

Related U.S. Application Data
(60) Provisional application No. 61/022,032, filed on Jan. 18, 2008.

(51) Int. Cl. C10L 1/18; B01J 19/00

(52) U.S. Cl. 44/308; 422/188

(57) ABSTRACT

The invention relates generally to a process and system for continuous removal of water during production of bio-fuels such as bio-diesel. The process may utilize either a homogeneous catalyst or a heterogeneous catalyst in an esterification reaction vessel to drive the esterification process to completion by continuously removing water and returning dried methanol back to the reaction vessel.

### CROSS REFERENCE TO RELATED APPLICATIONS

This application claims benefit and priority under 35 U.S.C. §119(e) from U.S. Provisional application No. 61/022,032 filed Jan. 18, 2008, entitled “Process and System for Preparation of Bio-fuels,” the disclosure of which is incorporated by reference herein in its entirety.

### BACKGROUND

1. Field of the Invention

The invention generally relates to preparation of bio-fuel and, more particularly, to a system and process that includes continuous water removal during the esterification process preceding transesterification during the preparation of the bio-fuel such as bio-diesel.

2. Related Art

Bio-fuels such as bio-diesel fuels are becoming more prevalent as an alternative source of fuel. In many aspects, the production of methyl or ethyl esters from fatty acids and triglycerides, such as found in animal and vegetable fats, has become quite central to producing the bio-fuels.

The production of bio-fuels is influenced by many factors including cost of materials such as the feedstock (e.g., unrefined vegetable oils, fats from slaughtered animals, virgin or recycled oleins and vegetable oil, and waste fats, etc.). In general, about 60-80% of the cost of producing bio-fuels is related to feedstock. Therefore, lower cost feedstock is sought to offset overall costs.

Typically, lower cost feedstock comprises triglycerides that have organic acidity due to the high quantities of free fatty acids (FFA), necessitating a robust acid-catalyzed esterfication process to reduce the FFA content. Traditional transesterfication processes cannot employ fats or oils with FFA acidity exceeding about 0.5% by weight (expressed as oleic acid) because the free acidity produces, by reacting with and consuming the basic catalyst (e.g., potassium hydroxide or sodium methoxide), soaps that interfere with the production of methylesters. This creates complications due to the necessary separation of the byproduct glycerin from the methyl esters. Thus, the potential benefits from using lower cost raw feedstock are compromised.

When employing homogeneous catalysts during the esterfication processes, concentrated sulfuric acid (H₂SO₄) is most often used because of high acidity activity and economics. However, using standard ratios of acid to methanol, oils of higher than 5% FFA cannot be used because of incomplete esterfication. Higher amounts of H₂SO₄ are possible but create difficulties because of oxidation or sulfonation of unsaturated oils and with downstream neutralization before trans-reaction and post separation of effluents.

The use of heterogeneous catalysts (e.g., sulfonic acid bonded to carbon, sulfonic acid bonded to silicon, and sulfated metal oxides) during the esterfication process provide several advantages over homogenous catalysts. Some of these advantages include:
No polluting by-products are formed.
The catalysts do not have to be removed since they do not mix with the bio-fuel.
Lower separation costs.
Easily removed from reactions by filtration.
Less maintenance costs since these catalysts are not corrosive.
Excess catalysts can be used to drive reactions to completion without introducing difficulties in purification.
Recycling recovered catalysts are economical, environmentally sound, and efficient.
Ease of handling when dealing with expensive or time-sensitive catalysts which can be incorporated into flow reactors and automated processes.
Toxic, explosive and noxious reagents are often more safely handled when contained on solid-support.
Catalysts on solid-support react differently, mostly more selectively, than their unbound counterparts.

Examples of heterogeneous catalyst sulfonic acid bonded to carbon compounds include:
Polyfluorocarbon-CF₂—SO₃H
Polystyrene —CH₂—SO₃H
Poly(stryrene/divinylbenzene) —CH₂—SO₃H
Coal —CH₂—SO₃H
Specialty sulfonated carbonized sugar —CH₂—SO₃H (not readily available) These catalysts give incomplete esterification of high FFA oils under standard bio-fuel or bio-diesel reaction conditions.

An example of heterogeneous catalyst sulfonic acid bonded indirectly to silicon includes specialty chemically-modified mesoporous silicates —Si(OSi)₂—R—SO₃H (R is aliphatic or aromatic). This expensive catalyst gives higher esterification activity than the conventional acidic solid catalysts, but a special filtration system and much longer times and higher temperature/pressure are required than other common procedures.

Another example of a conventional heterogeneous catalyst is sulfated metal oxides, e.g., zirconia. This type of catalyst requires high temperature/pressure and/or specialized expensive countercurrent reactive columns, sometimes utilizing extraneous entraining agents which must be separated and recovered.

There are known processes for pre-esterfication of an oil containing FFA to then be used for transesterification, such as described in U.S. Pat. No. 4,698,186. This patent discloses a generic process using a sulfonated solid catalyst to esterify FFA in an oil feedstock. The feedstock oils disclosed are only 5% FFA. The reaction mixture is flash dried at 120° C. in example 1 and the dried oil and methanol are recovered separately from the main reaction. Thus, no continuous drying of the reaction mixture is disclosed, as disclosed herein, nor is dry methanol continuously returned; rather the drying is a post reaction operation.

International Patent Publication WO/2007/083213 discloses a process for preparation of bio-diesel. However, this disclosure also fails to disclose continuous drying of the reaction mixture nor is dry methanol continuously returned, as disclosed herein.

There is a need for robust homogenous and/or heterogeneous acid esterification systems for bio-fuels (e.g., bio-diesel) production utilizing high FFA feedstock (e.g., 10-100% FFA) which can be run at about 70° C. or less at atmospheric pressure, utilizing conventional and commercially available acids, and utilizing a process that can be added in a “modular” fashion to existing manufacturing facilities or installed at new plants using conventional industrial equipment.

### SUMMARY OF THE INVENTION

The invention satisfies the above needs and avoids the disadvantages and provides a economical process for using lower cost feedstock that have higher percentages of free fatty acid. In one aspect, the process and system permits the esterification reaction as a first step in a bio-diesel production process, where the esterification is driven to completion by continuously removing water from the reaction mixture and returning dry methanol to the reaction vessel. Continuous drying and return of dried methanol drives the esterification reaction to completion quickly by removing water and by maintaining a constant excess of methanol. It also has an economic advantage over conventional post esterification drying, since it requires less cycle time (therefore greater throughput) and less equipment before transesterification for high FFA feedstocks and conventional set ups, where two stage esterification may ordinarily be required. The esterification product may then be transesterified by conventional techniques. This process may use commonly employed equipment and commercially available catalysts and feed stock.

According to another aspect of the invention, a process for production of a bio-fuel is provided that includes the steps of creating a esterification reaction mixture by placing one of a homogeneous catalyst and a heterogeneous catalyst in a reaction vessel so that one of the catalysts contacts methanol and a feed stock comprising free fatty acid (FFA) or a FFA-containing triglyceride in the reaction vessel, continuously drying the methanol during the reaction by removing water, and returning the dried methanol to the reaction vessel until the percentage of FFA reaches a predetermined value.

In another aspect, a process for production of bio-diesel is provided including drying methanol present during an esterification reaction by removing water, the esterification reaction including a feed stock comprising free fatty acid (FFA) or a FFA-containing triglyceride, the feedstock having an initial percentage of FFA and returning the dried methanol to the esterification reaction until the percentage of FFA reaches a predetermined value or until the reaction has run for a predetermined amount of time known to produce approximately the predetermined value.

In another aspect, an apparatus for producing bio-diesel is provided including means for creating a esterification reaction including one of a homogeneous catalyst and a heterogeneous catalyst so that one of the catalysts contacts methanol and a feed stock comprising free fatty acid (FFA) or a FFA-containing triglyceride, the feedstock having an initial percentage of FFA, means for drying the methanol during the reaction by removing water and means for returning the dried methanol to the esterification reaction until the percentage of FFA reaches a predetermined value or until a predetermined amount of reaction time has elapsed known to produce approximately the predetermined value.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and various ways in which it may be practiced. In the drawings:

FIG. 1 is an exemplary embodiment of a system configured for continuous removal of water during production of bio-fuels, according to principles of the invention;

FIG. 2 is another exemplary embodiment of a system configured for continuous removal of water during production of bio-fuels, according to principles of the invention;

FIG. 3 is another exemplary embodiment of a system configured for continuous removal of water during production of bio-fuels, according to principles of the invention; and

FIG. 4 is another exemplary embodiment of a system configured for continuous removal of water during production of bio-fuels, according to principles of the invention.

### DETAILED DESCRIPTION OF THE INVENTION

It is understood that the invention is not limited to the particular methodology, protocols, and reagents, etc., described herein, as these may vary as the skilled artisan will recognize. It is also to be understood that the terminology used herein is used for the purpose of describing particular embodiments only, and is not intended to limit the scope of the invention. It also is noted that as used herein and in the appended claims, the singular forms “a,” “an,” and “the” include the plural reference unless the context clearly dictates otherwise. Thus, for example, a reference to “a lesion” is a reference to one or more lesions and equivalents thereof known to those skilled in the art.

Unless defined otherwise, all technical and scientific terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

In certain aspects, the invention includes providing for a process utilizing either a homogenous acid (e.g., H₂SO₄) or heterogeneous catalyst (e.g., solid sulfonic acids), which contacts the methanol and a free fatty acid (FFA) or FFA-containing triglyceride at a preferred temperature range of about 50° to about 70° C. and at substantially atmospheric pressure in a stirred reaction vessel or packed reaction column while water is continuously removed, and dry methanol continuously returned. In this way at least 98 to about 99.5% esterification may be accomplished within about three hours. The continuous water removal may be accomplished by any (or any combination) of:

a) water absorption on a solid desiccant (e.g., CaSO₄) by contact in the esterification vessel.

b) water absorption on a solid desiccant (e.g., CaSO₄) by pumping the reaction mixture through a column packed with the desiccant and returning the dried mixture to the vessel.

c) passing refluxing wet methanol vapors through a rectifying column (e.g., fractional distillation column) so that dry methanol is continuously returned to the reaction chamber.

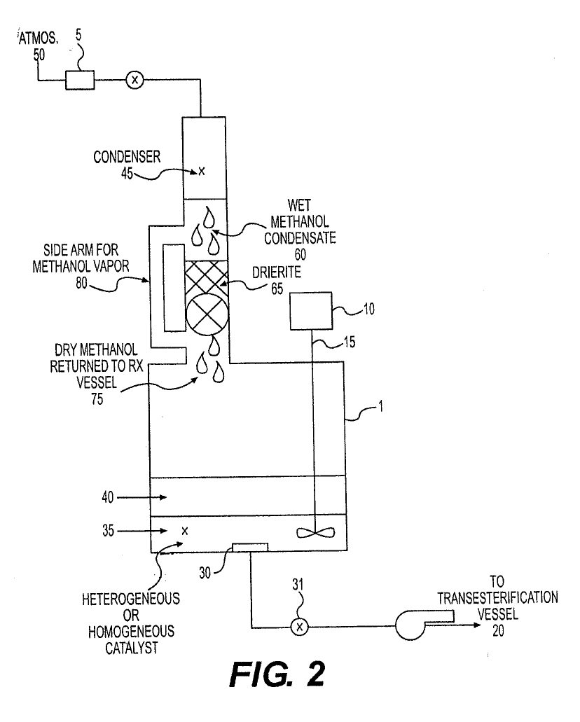

d) water absorption on a solid desiccant (e.g., CaSO₄) by refluxing wet methanol vapors up the side arm of a column packed with desiccant to a condenser positioned above the column. The wet condensed methanol falls and flows through the column, returning dry methanol to the reaction vessel (as in FIG. 2).

In one embodiment, a heated agitated reaction vessel containing oil, methanol, and a solid sulfonated catalyst (preferably Nafion, Dowex, Amberlite 15, or Purolite) may be attached to a rectifying column so that refluxing wet methanol vapors (containing water as the esterfication progresses) can enter the column. In this way the methanol is dried, and the dry condensed methanol returned in a continuous fashion to the reaction vessel by exiting the top of the column. Water exits the bottom of the column and may be stored separately for other use or disposal.

When the percent of FFA reaches a predetermined value (e.g., about 0.5%), the oil may be pumped out of the reaction vessel, through a filter, and into the transesterification vessel for final conversion into bio-fuel (e.g., bio-diesel). The filter typically retains the original catalyst in the esterification reaction vessel for reuse with the next charge of oil and methanol. Alternatively, in a non-preferred embodiment, a temperature range of about 40-100° C. may be employed, perhaps with some added pressure.

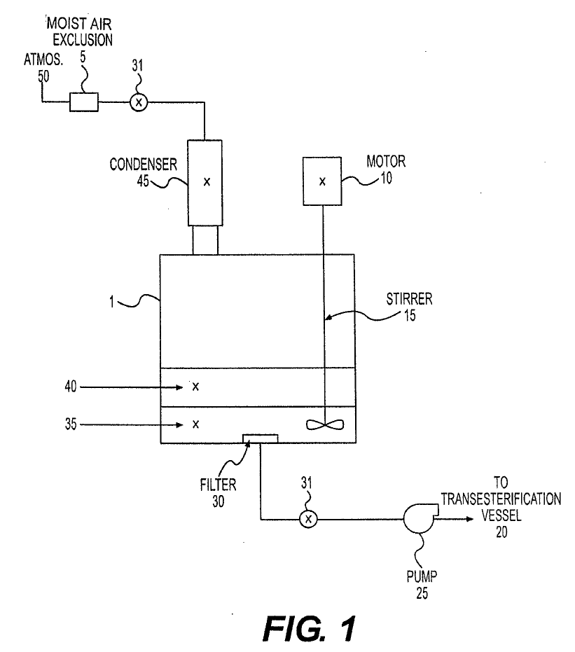

FIG. 1 is exemplary embodiment of a system configured for continuous removal of water during production of bio-fuels, according to principles of the invention. A reaction vessel 1 contains feedstock 35 and methanol 40 (and may also contain a drying agent such as Drierite, perhaps suspended in the mixture, and/or a catalyst as discussed previously) which is stirred by a stirrer 15 by a motor 10. A condenser 45 connected to the reaction vessel 1 and vented to atmospheric pressure 50 for removing water condensation, with a moist exclusion device 5. A filter 30 may be used to filter/retain Drierite or heterogeneous catalyst (when used in the reaction vessel 1). The reaction mixture may be pumped by pump 25 to a transesterification vessel 20 when the reaction has achieved its predetermined goal. The reaction mixture may be heated by known conventional mechanisms, and a temperature sensor such as a thermocouple (not shown) may be used to verify and aid in controlling the reaction mixture temperature. Appropriate valves 31 may be used to control flows such as controlling draining of the reaction mixture. Either a homogeneous or heterogeneous catalyst may be employed in the reaction vessel 1.

FIG. 2 is another exemplary embodiment of a system configured for continuous removal of water during production of bio-fuels, according to principles of the invention. A reaction vessel 1 having methanol 40 and feedstock 35 with a condenser 45 connected to the reaction vessel 1 having a side-arm 80 to permit methanol vapors to rise to the condensation area above the Drierite 65, where methanol condensate 60 may flow through the Drierite 65 to be dried and returned to the reaction vessel 1 for providing continuous drying of the methanol. In this way, only methanol contacts the Drierite 65. The reaction mixture may be heated by known conventional mechanisms, and a temperature sensor such as a thermocouple (not shown) may be used to verify and aid in controlling the reaction mixture temperature. A stirrer 15 and motor 10 may be employed to stir the mixture. The reaction is typically performed at atmospheric pressure. Either a homogeneous or heterogeneous catalyst may be employed in the reaction vessel 1.

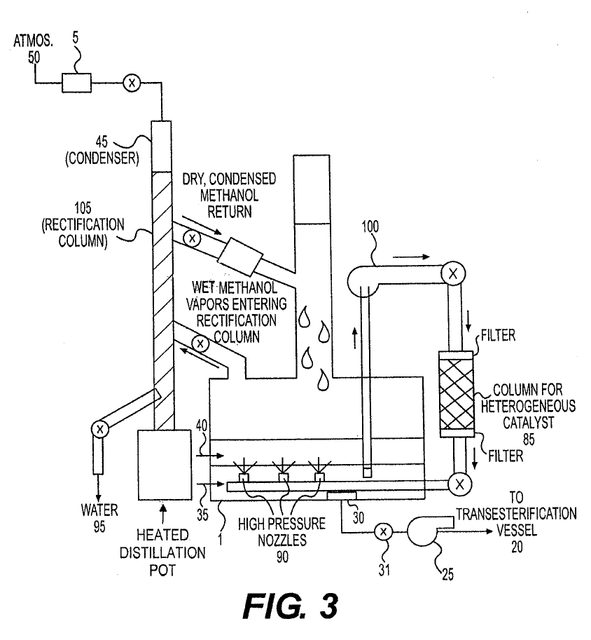

FIG. 3 is another exemplary embodiment of a system configured for continuous removal of water during production of bio-fuels, according to principles of the invention. A reaction vessel 1 containing feedstock and methanol may employ high pressure nozzles 90 to stir the reaction mixture. However, other techniques of stirring may be employed. A side-column 85 may be packed with heterogeneous catalyst. A pump 100 may pump the reaction mixture using a dip tube submersed in the reaction mixture through the side-column 85 so that the reaction mixture contacts the heterogeneous catalyst, returning the mixture to the reaction vessel 1. A rectifying column 105 may also provide a mechanism for wet methanol to be dried by condensation techniques and dry methanol continuously returned to the reaction vessel 1.

Alternatively, the side columns may be packed with Drierite (or other suitable drying agent) and a homogeneous catalyst used the reaction vessel 1 which contacts the methanol and feedstock. Further, in another configuration only one side column might be employed for drying. The reaction mixture may be stirred with any suitable method.

Typically, all reaction vessels have a filter 30 to filter the completed reaction mixture as the liquid mixture is pumped to the transesterification vessel. Optionally, the completed reaction mixture might go to an intermediate vessel where methanol is flashed off. The filter 30 retains Drierite (and/or other solid drying agent) and/or heterogeneous catalyst when appropriate.

In general, all condensers in these embodiments may be vented (with moist air exclusion mechanisms) to atmospheric pressure 50. The reaction vessels may vary in shape but preferably horizontal or vertical cylindrical-shaped tanks. All side-columns may have filters on each end to retain their packing; where two columns are used, they may be either in series or in parallel. Moreover, reactants may be pumped upward or downward through the side columns. Further, all reaction vessels may be charged initially with pre-dried feedstock and anhydrous methanol.

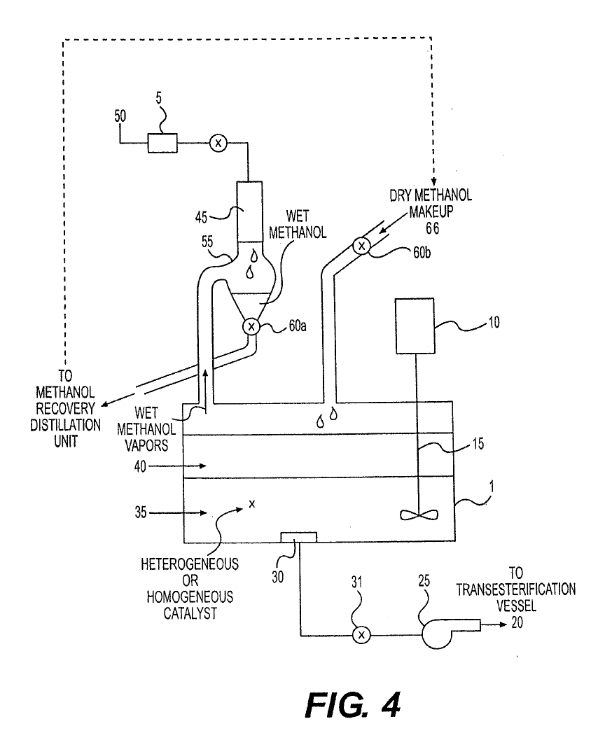

FIG. 4 is another exemplary embodiment of a system configured for continuous removal of water during production of bio-fuels, according to principles of the invention. A reaction vessel 1 containing feedstock 35 and methanol 40 may be stirred by a motor 10 and stirrer 15, or alternatively, by high pressure nozzles 90, such as shown in relation to FIG. 3. Wet methanol may be trapped or removed and collected in a collection vessel 55, which may be proximate condenser 45, and recovered for distillation and/or drying, and for eventual return to the reaction vessel 1. Methanol may be re-introduced at ingress 66 as makeup methanol into the reaction vessel 1, as needed, in a continuous fashion. This may be the dried or distilled methanol previously recovered as wet methanol.

The configuration and process of the embodiments herein may provide substantially continuous drying of the methanol during the esterification reaction so as to shift the esterification equilibrium to completion (e.g., a pre-determined level of FFA). Alternatively, the reactions of the embodiments may be permitted to run for a predetermined amount of time known to approximate the percentage of FFA, given a known set-up and starting mixture.

### EXPERIMENTAL RESULTS

Chemicals used in one or more experiments:
Drierite (anhydrous calcium sulfate) in granular form was obtained from the W.H. Hammond Drierite Co. LTD.
All feedstocks (SPF and SBO) were predried at 80° C. under vacuum.
All catalysts were in the acid form and were used as received.
Amberlite (Rohm & Haas) and Dowex (Dow Chemical Co.) were obtained from Sigma Aldrich and are macrorecticular cation exchange resins based on sulfonated polystyrene.
Purolite was obtained from the Purolite Company and is also a sulfonated polystyrene (a product of E.I. DuPont de Nemours).
Nafion is a sulfonated tetrafluoro ethylene copolymer and may be obtained from Ion Power, Inc.

### Experiment #1—Homogeneous Catalysis by a Standard Method (1× Standard)

A 250 ml three-necked, round-bottomed, standard taper flask was fitted with a reflux condenser (terminating in a drying tube to exclude moist air), a thermometer dipping into the flask contents, and a stirring gland/stirring shaft assembly with paddle. Into the third neck of the flask was introduced 100 g of stabilized poultry fat (SPF with a FFA content of 10%) and a solution of 0.5 g of sulfuric acid (98% H2SO4) dissolved in 29 ml of anhydrous methanol, and the neck stoppered.

The flask was heated with a water bath, with stirring (120 rpm), where the internal temperature of the reaction mixture was maintained at about 60° C. A sample of the oil phase was removed after one hour and found to be 1.1% by titration with 0.1% aqueous sodium hydroxide to a phenolphthalein endpoint.

### Experiment #2—Homogeneous Catalysis with Continuous Drying Using Suspended Drierite (½Standard)

Using the same set up and procedure as Exp. #1, the following were introduced to the flask:
100 g SPF (50% FFA)
74 ml methanol
1.3 g H₂SO4
50 g Drierite
   After 1 hour at 60° C., with stirring, a sample was removed, found to be 0.42% FFA. Thus, the goal of =<0.5% FFA was not reached in 1 hour starting with 10% FFA feedstock using the 1× standard method. In contrast, the goal was reached using only half the required methanol and H₂SO4 and a feedstock with five times the level of FFA (50%) using continuous drying with Drierite.

### Experiment #3—Heterogeneous Catalysis with Nafion and Suspended Drierite

A 250 ml three-necked, round bottom, standard taper flask was equipped with a reflux condenser and thermometer (as above) and a magnetic stirring bar. The following were introduced to the flask, through the third neck, which was then was stoppered:
58.5 g SPF (10% FFA)
44 ml methanol
17.5 g Hi-cat 1100 (Nafion)
10 g Drierite
   The flask was immersed in an oil bath and the flask contents heated at 60° C., while the contents were magnetically stirred (using a hot plate/magnetic stirrer). After one hour, a sample of the oil phase was found to be 0.47% FFA.

### Experiment #4—Heterogeneous Catalysis Using Suspended Nafion with a Drierite Column above the Reaction Vessel

The flask of Experiment #3 was fitted with a thermometer, a magnetic stirring bar, and a side-armed, standard taper addition funnel. The top joint of the funnel was fitted with a reflux condenser and drying tube. Into the flask was introduced 58.5 g SPF (10% FFA), 44 ml methanol, and 17.5 g Hi-cat. Into the addition funnel was introduced 10 g of Drierite, retained by a small-bored stopcock. The contents were heated to 65° C. with an oil bath and hot plate stirrer as in the last example. The refluxing methanol was allowed to condense in the condenser, drain through the Drierite, and return through the open stopcock to the flask. After 1 hour at reflux, a sample of the oil phase was found to be 0.50% FFA.

### Experiment #5—Heterogeneous Catalysis Using Suspended Purolite with Drierite Positioned above the Reaction Vessel

Using the set up of Experiment #4, the following were introduced to the flask, which was then re-stoppered:
50.2 g SPF (10% FFA)
31 ml methanol
20 g Purolite PD 206
   The addition funnel was loaded with 7.5 g Drierite. After one hour and two hours at reflux, oil samples were taken and found to be 1.1% and 0.30% FFA, respectively.

### Experiment #6—Heterogeneous Catalysid Using Suspended Dowex with Drierite Positioned above the Reaction Vessel

Using the set up of Experiment #4, the following were introduced to the flask, which was then re-stoppered:
50.0 g SPF (10% FFA)
31 ml methanol
20 g Dowex DR2030
   The addition funnel was loaded with 7.5 g Drierite. After 60 and 90 minutes oil samples were found to be 0.89 and 0.15% FFA, respectively. Thus, this process allows the use of the above mentioned advantages of a heterogeneous catalyst, at least equaling the results of a standard method using a homogeneous catalyst and in certain cases exceeding it.

Table 1 summarizes additional experiments 6A-11C. The experiments each have a CONTROL experiment always designated as the “B” experiment (e.g., 6B or 7B, etc.), which are the experiments that employed no continuous drying of the esterification reaction. The other experiments (e.g., 6A, 7A, 7C, 8A, 9A, 10A, 11A, 11C) employ a technique of continuous drying performed according to principles of the invention.

In Table 1, the column labeled “REACTION CONDITION” shows the parameters of the reaction for the experiments as denoted under the column “EXPERIMENT.” The reaction condition may include the temperature in ° C., reaction time duration in hours, reflux, and if an inert gas (e.g., helium) was used to add additional drying. The column labeled “Feedstock” shows the amount of feedstock, e.g., stabilized poultry fat (SPF) or soy bean oil (SBO), in grams. The column labeled “Initial % FFA” shows the initial percentage of FFA by weight of the feedstock. The column labeled “CH3OH” shows the amount of methanol used for each experiment. The column labeled “CAT” shows the type and amount of catalyst used such as Hicat 1100, Amberlite 15 or Dowex DR 2030. The column labeled “Other” shows the amount of drying agent (e.g., Drierite) or other technique of drying. The column labeled “Final % FFA” shows the final percent of FFA remaining after the experiment time period. As can be seen in these results, the final % FFA is always higher in the CONTROL experiment which uses no drying of the methanol. Therefore, it may be concluded that continuous drying of the methanol improves effectiveness of the esterification reaction.

### Notes on Table 1:

All flasks were heated with an oil bath (to the point of refluxing the methanol) and then agitated with a magnetic stirrer (MS) and stirring bar.
The set ups are the same as described in Example 3 or 4 (depending on whether a side arm addition funnel was used or not) except water baths are replaced by the oil baths.
The helium purge in Experiment 11c was accomplished by bubbling helium through the liquid reaction mixture in the flask to help dry the methanol. Moreover, the inert gas purge may be also be used to continuously renew the catalyst. For example, the catalyst may have water adsorbed on its surface, and the inert gas purge may remove a portion of the adsorbed water thereby renewing the effectiveness of the catalyst.

TABLE 1

| REACTION | | | Initial | | | | Final | |
|---|---|---|---|---|---|---|---|---|
| CONDITION | Feedstock | | % FFA | CH30H | CAT | Other | % FFA | EXPERIMENT |
| 65° C./1 hr | 50 | g SPF | 10.6 | 40 ml | Hicat 1100 | 10 g | 0.51 | 6A |
| (reflux) MS | | | | | 4.5 g | Drierite in | | |
| | | | | | | add'n | | |
| | | | | | | funnel | | |
| 65° C./1 hr | 50 | g SPF | 10.6 | 40 ml | Hicat 1100 | CONTROL | 0.91 | 6B |
| (reflux) MS | | | | | 4.5 g | (no drying) | | |
| 65° C./1 hr | 25 | g SBO | 20 | 40 ml | Amberlite | 30 g | 0.44 | 7A |
| (reflux) MS | | | | | 15 | Drierite in | | |
| | | | | | 7.5 g | add'n | | |
| | | | | | | funnel | | |
| 24 | 25 | g SBO | 20 | 40 ml | Amberlite | CONTROL | 0.62 | 7B |
| 65° C./1 hr | | | | | 15 | (no drying) | | |
| (reflux) MS | | | | | 7.5 g | | | |
| 65° C./1 hr | 25 | SBO | 20 | 40 ml | Amberlite | 7.5 g | 0.29 | 7C |
| (reflux) MS | | | | | 15 | Drierite in | | |
| | | | | | 7.5 g | rx flask | | |
| 65° C./1 hr | 25 | g SBO | 20 | 40 ml | Amberlite | 10 g | 1.27 | 8A |
| (reflux) MS | | | | | 15 | Drierite in | | |
| | | | | | 2.5 g | rx flask | | |
| 65° C./1 hr | 25 | g SBO | 20 | 40 ml | Amberlite | CONTROL | 2.82 | 8B |
| (reflux) MS | | | | | 15 | (no drying) | | |
| | | | | | 2.5 g | | | |
| 65° C./1 hr | 25 | g SBO | 20 | 40 ml | Amberlite | 10 g | 0.5 | 9A |
| (reflux) MS | | | | | 15 | Drierite in | | |
| | | | | | 4 g | rx flask | | |
| 65° C./1 hr | 25 | g SBO | 20 | 40 ml | Amberlite | CONTROL | 1.73 | 9B |
| (reflux) MS | | | | | 15 | (no drying) | | |
| | | | | | 4 g | | | |
| 65° C./1 hr | 25 | g SBO | 20 | 40 ml | Dowex | 10 g | 1.69 | 10A |
| (reflux) MS | | | | | DR 2030 | Drierite in | | |
| | | | | | 3.75 g | add'n | | |
| | | | | | | funnel | | |
| 65° C./1 hr | 25 | g SBO | 20 | 40 ml | Dowex | CONTROL | 2.73 | 10B |
| (reflux) MS | | | | | DR 2030 | (no drying) | | |
| | | | | | 3.75 g | | | |
| 65° C./2 hr | 25 | g SBO | 20 | 15 ml | Dowex | 20 g | 1.63 | 11A |
| (reflux) MS | | | | standard | DR 2030 | Drierite in | | |
| | | | | | 3.25 g | add'n | | |
| | | | | | | funnel | | |
| 65° C./2 hr | 25 | g SBO | 20 | 15 ml | Dowex | CONTROL | 3.24 | 11B |
| (reflux) MS | | | | standard | DR 2030 | (no drying) | | |
| | | | | | 3.25 g | | | |
| 65° C./2 hr | 33.3 | g SBO | 20 | 20 ml | Dowex | Collect wet | 0.87 | 11C |
| (reflux) MS | | | | standard | DR 2030 | MEOH in | | |
| Helium purge | | | | | 4.33 g | one funnel; | | |
| | | | | | | add dry | | |
| | | | | | | MEOH | | |
| | | | | | | from 2^{nd} | | |
| | | | | | | funnel | | |

The examples given above are merely illustrative and are not meant to be an exhaustive list of all possible embodiments, applications or modifications of the invention. Thus, various modifications and variations of the described methods and systems of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention which are obvious to those skilled in the cellular and molecular biology fields or related fields are intended to be within the scope of the appended claims.

The disclosures of any patents, references and publications cited above are expressly incorporated by reference in their entireties to the same extent as if each were incorporated by reference individually.

What is claimed is:

1. A process for production of bio-diesel, comprising the steps of:
creating a esterification reaction mixture by placing one of a homogeneous catalyst and a heterogeneous catalyst in a esterification reaction vessel so that one of the catalysts contacts methanol and a feed stock comprising free fatty acid (FFA) or a FFA-containing triglyceride in the esterification reaction vessel to create a reaction;
continuously drying the methanol during the reaction by removing water; and
returning the dried methanol to the esterification reaction vessel until the percentage of FFA reaches a predetermined value.

2. The process of claim 1, wherein the predetermined value is about 0.5% FFA.

3. The process of claim 1, wherein the feedstock comprises at least one of a vegetable oil and an animal fat.

4. The process of claim 1, wherein the step of continuously drying includes adsorption of the water on a solid desiccant.

5. The process of claim 1, wherein the step of continuously drying includes adsorption on a solid desiccant within the esterification reaction vessel.

6. The process of claim 1, wherein the step of continuously drying includes pumping the reaction mixture through a packed column packed with a solid desiccant and returning the mixture to the esterification reaction vessel.

7. The process of claim 1, wherein the step of continuously drying includes refluxing the reaction mixture so that wet methanol is condensed and drained through a column packed with a solid desiccant and returned to the esterification reaction vessel.

8. The process of claim 1, wherein the step of continuously drying includes passing refluxing wet methanol vapors through a rectifying column to separate the water from the methanol, wherein the dried methanol from the column is continuously returned to the esterification reaction vessel.

9. The process of claim 8, wherein the wet methanol vapors are condensed and held in a side-armed holding vessel and the wet methanol condensate gradually fed via a valve to a rectifying column for drying, wherein the dried methanol from the column is continuously returned to the esterification reaction vessel during the reaction.

10. The process of claim 1, wherein the homogenous catalyst comprises sulfuric acid.

11. The process of claim 1, wherein the heterogeneous catalyst comprises a solid sulfonated catalyst.

12. The process of claim 11, wherein the solid sulfonated catalyst is nation.

13. The process of claim 1, further comprising the steps of:
removing the reaction mixture from the esterification reaction vessel; and
transesterifying the removed reaction mixture.

14. The process of claim 1, further comprising the steps of pumping resulting oils from the reaction vessel after reaching the predetermined value through a filter into a final transesterification vessel for final conversion into bio-fuel.

15. The process of claim 14, wherein the filter retains the heterogeneous catalyst in the reaction vessel for reuse in a next process cycle with new feedstock.

16. The process of claim 1, wherein the step of continuously drying includes condensing wet methanol vapors into a holding vessel and adding dry makeup methanol to the reaction vessel, wherein the wet methanol is pumped to a rectification column for water/methanol separation.

17. A bio-fuel made at least in part by the process of claim 1.

18. The process of claim 1, wherein the drying step includes purging with an inert gas to further augment drying of the methanol.

19. The process of claim 1, further comprising purging with an inert gas to renew at least one of the catalysts.

20. A process for production of bio-diesel, comprising the steps of:
drying methanol present during an esterification reaction by removing water, the esterification reaction including a feed stock comprising free fatty acid (FFA) or a FFA-containing triglyceride, the feedstock having an initial percentage of FFA; and
returning the dried methanol to the esterification reaction until the percentage of FFA reaches a predetermined value or until the reaction has run for a predetermined amount of time known to produce approximately the predetermined value.

21. The process of claim 20, wherein the predetermined value is about 0.5% FFA.

22. The process of claim 20, wherein the feedstock comprises at least one of a vegetable oil and an animal fat.

23. The process of claim 20, further comprising combining one of a homogeneous catalyst and a heterogeneous catalyst with the methanol and the feedstock.

24. A bio-fuel made at least in part by the process of claim 20.

25. The process of claim 20, wherein the step of drying dries the methanol external to a reaction vessel containing the reaction mixture and the step of returning continuously returns the dried methanol to the reaction mixture during the esterification reaction until the predetermined value has been reached or until the reaction has run for the predetermined amount of time.

26. An apparatus for producing bio-diesel, comprising:
means for creating a esterification reaction including one of a homogeneous catalyst and a heterogeneous catalyst so that one of the catalysts contacts methanol and a feed stock comprising free fatty acid (FFA) or a FFA-containing triglyceride, the feedstock having an initial percentage of FFA;
means for drying the methanol during the reaction by removing water; and
means for returning the dried methanol to the esterification reaction until the percentage of FFA reaches a predetermined value or until a predetermined amount of reaction time has elapsed known to produce approximately the predetermined value.

27. The apparatus of claim 26, wherein the predetermined value is about 0.5% FFA.

28. The apparatus of claim 26, wherein the feedstock comprises at least one of a vegetable oil and an animal fat.

29. The apparatus of claim 26, wherein means for drying dries the methanol substantially continuously during the reaction.
